(19) United States
(12) Patent Application Publication
(10) Pub. No.: US 2018/0117814 A1
(43) Pub. Date: May 3, 2018

(54) METHOD OF MOLDING MOLDED ARTICLE, MOLDED ARTICLE AND DIE

(71) Applicant: KABUSHIKI KAISHA TOKAI-RIKA-DENKI-SEISAKUSHO, Aichi-ken (JP)

(72) Inventors: Keisuke YAMADA, Aichi-ken (JP); Tomoyuki TAKEYAMA, Aichi-ken (JP); Koichi YANO, Aichi-ken (JP)

(21) Appl. No.: 15/794,247

(22) Filed: Oct. 26, 2017

(30) Foreign Application Priority Data
Oct. 31, 2016 (JP) 2016-213564

(51) Int. Cl. B29C 45/44; B29C 45/26; B29C 45/33

(52) U.S. Cl. CPC B29C 45/4435; B29L 2031/3041; B29C 45/33; B29C 45/2628

(57) ABSTRACT

A method of molding a molded article, the method employing a die provided with a die main body including a movable mold and a fixed mold, a first slide core that is disposable inside the die main body, and a second slide core that is disposable inside the die main body in a state intersecting with the first slide core, and the method including: a mold-closing step including closing the die main body, disposing the first slide core inside the die main body, and disposing the second slide core inside the die main body to intersect with the first slide core; and a charging step of charging a molding material into the inside of the die, an undercut portion of the molded article being molded by the first slide core and the second slide core.

### CROSS-REFERENCE TO RELATED APPLICATION

This application is based on and claims priority under 35 USC 119 from Japanese Patent Application No. 2016-213564 filed on Oct. 31, 2016, the disclosure of which is incorporated by reference herein.

### BACKGROUND

### Technical Field

The present disclosure relates to a method of molding a molded article, the molded article, and a die for molding the molded article.

### Related Art

When a molded article that includes an undercut portion is being molded, as disclosed in, for example, Japanese Patent Application Laid-Open (JP-A) No. 2004-345129, a slide core is provided in a die. The slide core is slidable to an opening side of the undercut portion and to a side in the opposite direction, and the undercut portion is molded by this slide core.

However, integral molding of a molded article is difficult when the structure of an undercut portion is complex; for example, a structure in which a portion of an undercut portion is undercut both with respect to the movement direction of a movable mold relative to a fixed mold of the die and with respect to the sliding direction of a slide core, or the like.

Accordingly, a molded article with this kind of structure is divided into a plural number of parts and is formed by the plural parts being molded and assembled. In consequence, there are gaps, steps and the like between the parts of this molded article.

### SUMMARY

In consideration of the circumstances described above, the present disclosure provides a molding method for a molded article that includes an undercut portion with a complex structure, a molded article that both includes the undercut portion and may suppress the production of gaps, steps and the like, and a die that may mold the molded article including the undercut portion.

A method of molding a molded article according to a first aspect employs a die provided with a die main body including a movable mold and a fixed mold, a first slide core that is disposable inside the die main body, and a second slide core that is disposable inside the die main body in a state intersecting with the first slide core, and the method includes a mold-closing step including closing the die main body, disposing the first slide core inside the die main body, and disposing the second slide core inside the die main body to intersect with the first slide core; and a charging step of charging a molding material into the inside of the die, an undercut portion of the molded article being molded by the first slide core and the second slide core.

In the method of molding a molded article of the first aspect, the second slide core is disposed at the inside of the die main body to intersect with the first slide core. In this state, the molding material for the molded article is charged into the die, and the undercut portion of the molded article is molded by the first slide core and the second slide core. Therefore, an undercut portion with a complex structure that could not be molded by the first slide core alone may be integrally molded in the molded article.

In a method of molding a molded article according to a second aspect, in the method of the first aspect, the mold-closing step includes, when the die main body is being closed: moving the movable mold in a mold-closing direction, moving the first slide core in a first direction that intersects the mold-closing direction, and moving the second slide core in a second direction that intersects both the mold-closing direction and the first direction.

According to the method of molding a molded article of the second aspect, in the mold-closing step the first slide core is moved in the first direction, which intersects the mold-closing direction, and the second slide core is moved in the second direction, which intersects both the mold-closing direction and the first direction. Thus, the second slide core is disposed to intersect with the first slide core inside the die main body. Hence, in a state in which the molded article has been molded, the first slide core and the second slide core may be removed from the undercut portion of the molded article by the second slide core being moved in the opposite direction to the second direction and the first slide core being moved in the opposite direction to the first direction.

In a method of molding a molded article according to a third aspect, in the method of the first aspect, the mold-closing step includes disposing the second slide core in the state in which the second slide core intersects with the first slide core by disposing the second slide core at an inside of an arrangement portion formed in the first slide core, the second slide core being movable in the second direction and an opposite direction thereto, and causing a second direction side portion of the second slide core to protrude to an outside of the arrangement portion in a state in which the mold has been closed.

In the method of the third aspect, the second slide core is disposed in the arrangement portion of the first slide core, and the second direction side portion of the second slide core is protruded to the second direction side from the arrangement portion. As a result, a first direction side face of the first slide core and a second direction side face of the second slide core may be made continuous in a direction intersecting both the first direction and the second direction. Hence, a face of the undercut portion of the molded article in a circumferential direction around an axial direction that is the direction intersecting both the first direction and the second direction may be made continuous.

A molded article according to a fourth aspect includes a molded article main body that opens out in a predetermined direction, and an undercut portion formed integrally with the molded article main body, the undercut portion including regions that oppose one another in the predetermined direction, a space between the regions that oppose one another in the predetermined direction opening out to a first opening direction side, the first opening direction intersecting the predetermined direction, and a first opening direction middle portion of the space between the opposing regions opening out to a second direction side, the second direction intersecting both the predetermined direction and the first opening direction.

According to the molded article of the fourth aspect, the undercut portion of the molded article includes the regions that oppose one another in the predetermined direction, which is the opening direction of the molded article main body, the first opening direction intersects the predetermined direction, and the first opening direction side of the space between the regions that oppose one another in the predetermined direction is open. The second opening direction intersects both the predetermined direction and the first opening direction. The second opening direction side of the first opening direction middle portion of the space between the regions of the undercut portion that oppose one another in the predetermined direction is open.

In this molded article, because this undercut portion may be formed integrally with the molded article main body, the production of gaps, steps and the like at the undercut portion may be suppressed.

A die according to a fifth aspect includes a die main body including a movable mold and a fixed mold, a molding material for a molded article being charged into an inside of the die main body in a mold-closed state, a first slide core disposed inside the die main body, the first slide core molding an undercut portion of the molded article, and a second slide core disposed inside the die main body to intersect with the first slide core, the second slide core molding the undercut portion together with the first slide core.

In the die of the fifth aspect, the molding material for the molded article is charged into the die main body of the die in the state in which the second slide core is disposed to intersect with the first slide core. Thus, the undercut portion of the molded article is molded by the first slide core and the second slide core. Therefore, an undercut portion with a complex structure that could not be molded by the first slide core alone may be integrally molded in the molded article.

In a die according to a sixth aspect, in the die of the fifth aspect, the first slide core is movable in a first direction and an opposite direction thereto, the first direction intersecting a mold-closing direction that is a movement direction of the movable mold when the die main body is being closed, and the second slide core is movable in a second direction and an opposite direction thereto, the second direction intersecting both the mold-closing direction and the first direction.

In the die of the sixth aspect, the first slide core is movable in the first direction intersecting the mold-closing direction and in the opposite direction to the first direction, and the second slide core is movable in the second direction intersecting both the mold-closing direction and the first direction and in the opposite direction to the second direction. Therefore, the first slide core and the second slide core can be removed from the undercut portion of the molded article formed by the first slide and the second slide core.

In a die according to a seventh aspect, the die of the fifth aspect further includes an arrangement portion formed in the first slide core, the second slide core being disposed at an inside of the arrangement portion to be movable in the second direction and the opposite direction thereto, wherein, in the mold-closed state of the die main body, a second direction side portion of the second slide core protrudes to an outside of the arrangement portion.

In the die of the seventh aspect, in the state in which the second slide core intersects with the first slide core, the second slide core is disposed in the arrangement portion of the first slide core and the second direction side portion of the second slide core is protruded to the second direction side from the arrangement portion. As a result, a first direction side face of the first slide core and a second direction side face of the second slide core may be made continuous in a direction intersecting both the first direction and the second direction. Hence, a face of the undercut portion of the molded article in a circumferential direction around an axial direction that is the direction intersecting both the first direction and the second direction may be made continuous.

As described above, with the method of molding a molded article and the die relating to the present disclosure, a molded article including an undercut portion with a complex structure may be molded.

Moreover, in the molded article relating to the present disclosure, because the undercut portion may be formed integrally with the molded article main body, the production of gaps, steps and the like may be suppressed.

### BRIEF DESCRIPTION OF THE DRAWINGS

Exemplary embodiments of the present invention will be described in detail based on the following figures, wherein:

FIG. 1 is a perspective view of a visor rim according to an exemplary embodiment of the present disclosure;

FIG. 2 is a view of the visor rim according to the exemplary embodiment of the present disclosure, seen from a front side;

FIG. 3 is a sectional diagram of a fixed mold and a movable mold, showing a mold-closed state of a die;

FIG. 4A is a perspective view showing states of a first slide core and a second slide core in a state before mold-closing of the die;

FIG. 4B is a perspective view showing states of the first slide core and the second slide core in the mold-closed state of the die; and

FIG. 5 is a perspective view showing a region of the visor rim that is molded by the first slide core and the second slide core.

### DETAILED DESCRIPTION

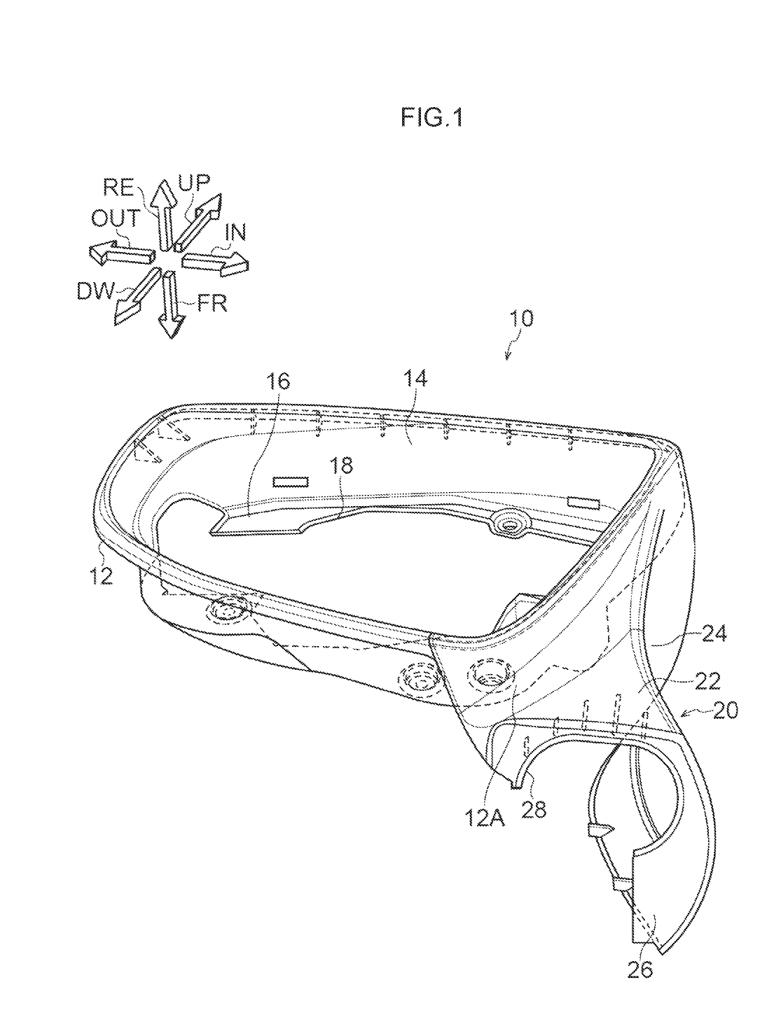

Now, an exemplary embodiment of the present disclosure is described in accordance with the drawings of FIG. 1 to FIG. 5. The present exemplary embodiment is an example in which the method of molding a molded article relating to the present disclosure is applied to molding of a visor rim 10 that serves as a vehicle cabin exterior equipment component to be disposed outside a passenger cabin of a vehicle, which is a mode of the molded article.

In the drawings, the arrow FR indicates the front side of a vehicle at which an electric door mirror device for a vehicle that includes the visor rim 10 is employed, and also indicates a mold-opening direction of a movable mold 46 that structures a die main body 42 of a die 40 in which the visor rim 10 is molded. The arrow RE indicates the rear side of the vehicle, and also indicates a mold-closing direction of the movable mold 46. The arrow OUT indicates a vehicle width direction outer side of the vehicle, the arrow IN indicates the vehicle width direction inner side, the arrow UP indicates the vehicle upper side, and the arrow DW indicates the vehicle lower side. —Structure of the Visor Rim 10—

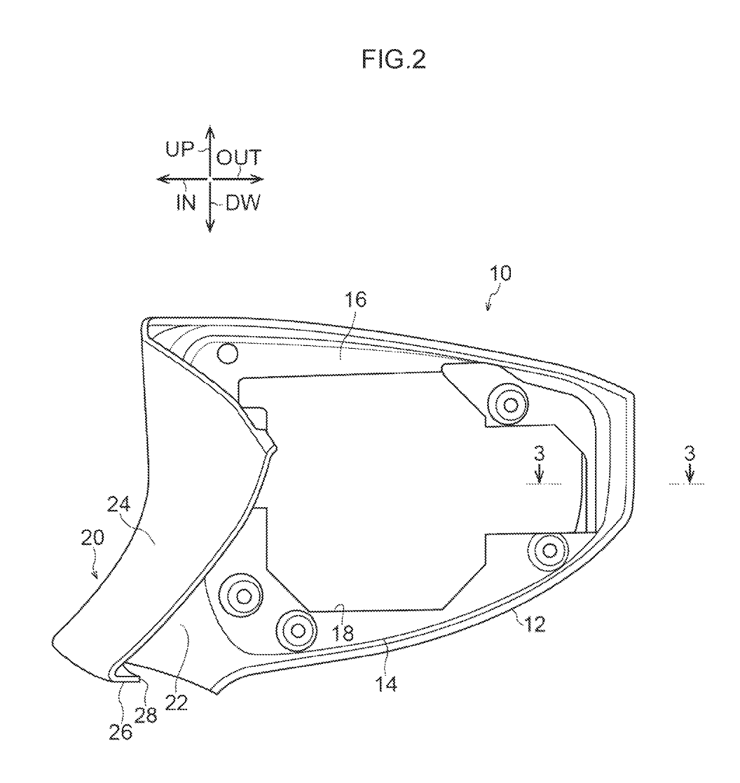

As shown in FIG. 1 and FIG. 2, the visor rim 10 is provided with a rim portion 12. The rim portion 12 is formed in a substantially rectangular frame shape as seen from the rear side. The rim portion 12 is provided with an extended portion 12A. The extended portion 12A is a portion of a vehicle width direction inner side region of the rim portion 12 that excludes an upper side end portion of the vehicle width direction inner side region. The extended portion 12A is extended to the front side. An upper side portion of the extended portion 12A is angled to the lower side toward the front side.

A mirror accommodation portion 14 is provided at the inner side of the rim portion 12. A shape of the mirror accommodation portion 14 viewed from the rear side is substantially a rectangular tube shape. The rear side of the mirror accommodation portion 14 is open. The rim portion 12 and the mirror accommodation portion 14 are molded integrally, with the rear side end of the rim portion 12 connecting with the rear side end of the mirror accommodation portion 14. Therefore, cross-sectional shapes of rear side end portions of the rim portion 12 and the mirror accommodation portion 14 are “U” shapes that open to the front side. A plate-shaped mirror (not shown in the drawings) is provided inside the mirror accommodation portion 14, in a rear side end portion vicinity of the mirror accommodation portion 14. A thickness direction of the mirror is broadly aligned with the front and rear direction, and a reflective surface of the mirror faces to the rear side.

A floor plate 16 is provided at the front side end of the mirror accommodation portion 14. The floor plate 16 and the mirror accommodation portion 14 are molded integrally, with outer periphery portions of the floor plate 16 connecting with the front side end of the mirror accommodation portion 14. An aperture portion 18 is formed in the floor plate 16. As an example, a mirror surface adjustment device (not shown in the drawings), which adjusts the angle of the reflective surface of the mirror with respect to the vehicle, is disposed at the inner side of the aperture portion 18. Further, for example, a bracket (not shown in the drawings) is disposed at the vehicle front side of the floor plate 16. The mirror surface adjustment device and the floor plate 16 of the mirror accommodation portion 14 are attached to vehicle width direction outer side portions of the bracket.

An electric circuit accommodation portion 20 that serves as an undercut portion is provided at the vehicle width direction inner side of the mirror accommodation portion 14. The electric circuit accommodation portion 20 is provided with a rear plate 22. The rear plate 22 is formed in a substantially triangular plate shape, with a thickness direction of the rear plate 22 broadly in the front and rear direction. The rear plate 22 extends to the vehicle width direction inner side from the front side end of the extended portion 12A of the rim portion 12. The vehicle width direction inner side end of the rear plate 22 is angled to the vehicle width direction inner side toward the lower side.

A transverse plate 24 is provided at the vehicle width direction inner side of the rear plate 22 of the electric circuit accommodation portion 20. The transverse plate 24 is formed in a plate shape. The thickness direction of the transverse plate 24 at the rear side relative to a front and rear direction middle portion of the transverse plate 24 is broadly in the vehicle width direction. A lower side portion of a rear side end of the transverse plate 24 connects with the rear plate 22. The lower side portion is at the lower side relative to an up and down direction middle portion of the transverse plate 24. An upper side portion of the rear side end of the lateral plate 24 connects with the extended portion 12A of the rim portion 12. The upper side portion is at the upper side relative to the up and down direction middle portion. The upper side end of the lateral plate 24 connects with an upper end portion of the rim portion 12.

A rear side portion of the transverse plate 24 of the electric circuit accommodation portion 20 is at the rear side relative to the front and rear direction middle portion. A front side portion of the transverse plate 24 is at the front side relative to the front and rear direction middle portion. The rear side portion of the transverse plate 24 is offset gradually to the vehicle width direction outer side toward the lower side. Thus, a vehicle width direction outer side face of the front side portion of the transverse plate 24 is curved into a protruding shape that bulges in a direction that is angled to the lower side toward the vehicle width direction inner side. The front side portion relative to the front and rear direction middle portion of the transverse plate 24 is curved toward the vehicle width direction outer side. As shown in FIG. 2, a portion of the transverse plate 24 is disposed at the front side of the rear plate 22 of the electric circuit accommodation portion 20 and the floor plate 16 of the mirror accommodation portion 14, opposing the rear plate 22 and the floor plate 16 in the front and rear direction. A case (not shown in the drawings) of an electric folding device is disposed between the transverse plate 24 and the mirror accommodation portion 14 at the rear side of the rear plate 22. A vehicle width direction inner side portion of the bracket mentioned above is connected to this case.

A lower plate 26 is provided at the lower side of the rear plate 22 and the transverse plate 24. The lower plate 26 is formed in a plate shape. The thickness direction of the lower plate 26 is broadly in the up and down direction. A cutout 28 is formed in the lower plate 26. A stand is fixed to a door of the vehicle. A support shaft of the stand (not shown in any of the drawings) is disposed to penetrate through the cutout 28. The case of the electric folding device is supported at the support shaft to be turnable about the support shaft. —Structure of the Die 40—

Now, the die 40 for molding the visor rim 10 described above is described.

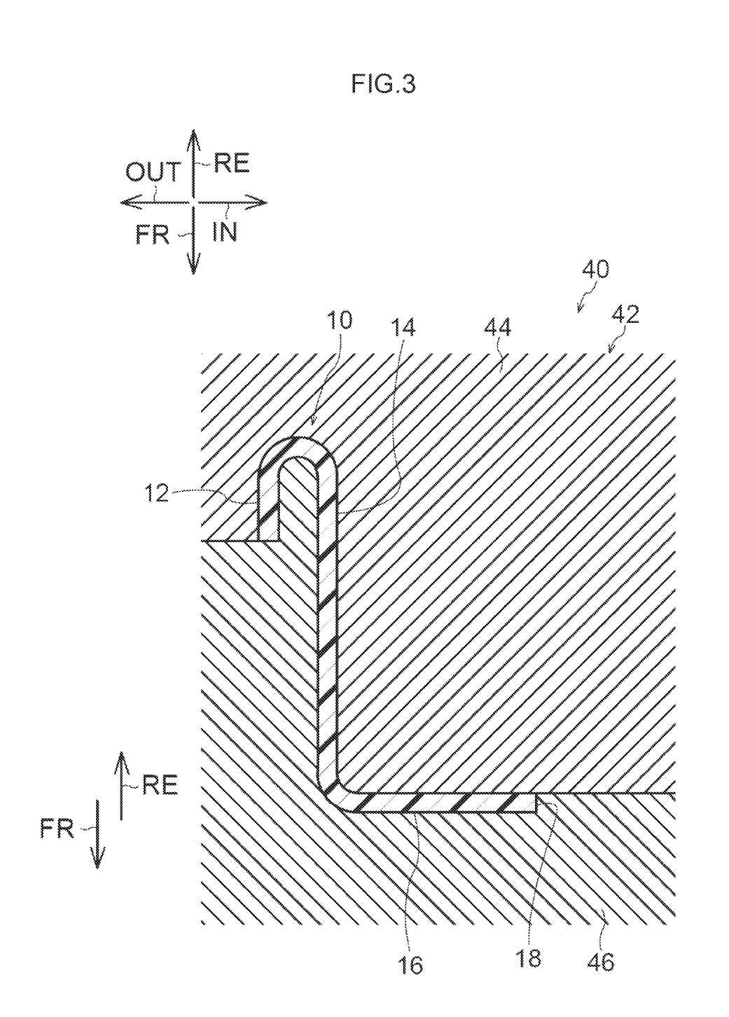

As shown in FIG. 3, the die 40 is provided with the die main body 42. The die main body 42 includes a fixed mold 44 and the movable mold 46. The movable mold 46 is movable linearly in a mold-closing direction approaching the fixed mold 44 (the direction of arrow RE in FIG. 3 and the like) and a mold-opening direction away from the fixed mold 44 (the direction of arrow FR in FIG. 3 and the like). The movable mold 46 is moved by a driving unit that is a hydraulic device, such as an oil cylinder or the like, an electric device, such as a motor or the like, or the like. A face of the movable mold 46 at the side thereof at which the fixed mold 44 is disposed and a face of the fixed mold 44 at the side thereof at which the movable mold 46 is disposed are formed with protrusions and recesses corresponding to the shape of the visor rim 10, which serves as the molded article. Shapes of a vehicle width direction outer side region of the visor rim 10 and the like at the vehicle width direction outer side relative to the electric circuit accommodation portion 20 are molded by the protrusions and recesses in the face of the movable mold 46 at the side thereof at which the fixed mold 44 is disposed and the face of the fixed mold 44 at the side thereof at which the movable mold 46 is disposed.

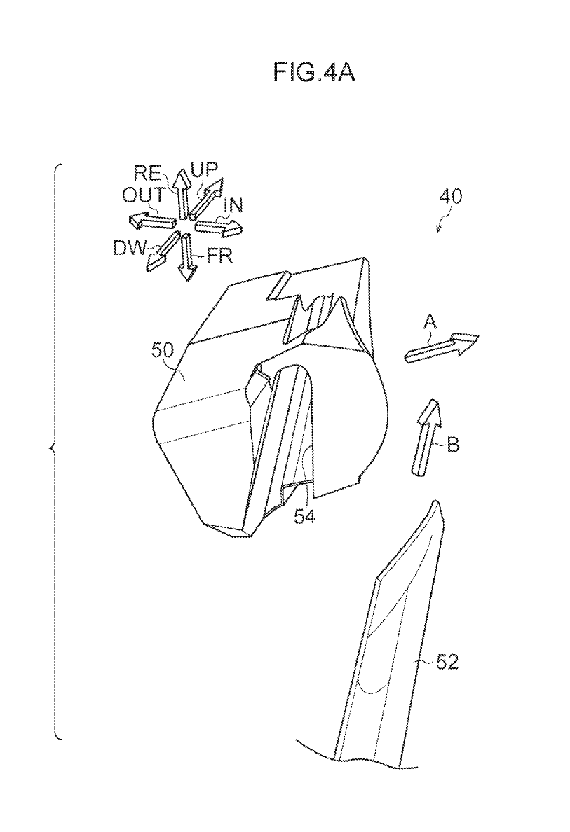

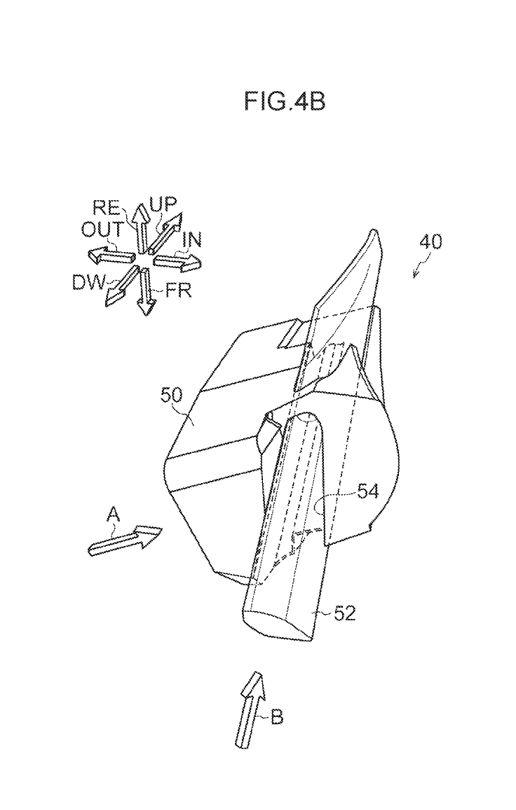

A first slide core 50 is provided at the movable mold 46 of the die 40. The first slide core 50 is disposed in a guide hole (not shown in the drawings) formed in the movable mold 46. The first slide core 50 is movable in a first direction (the direction of arrow A in FIG. 4A and the like) and the opposite direction to the first direction (a first opening direction). The first direction is angled to the right side of the die 40 (the direction of arrow IN in FIG. 4A and the like) toward the mold-closing direction (the direction of arrow RE in FIG. 4A and the like).

The first slide core 50 is made operable in conjunction with the movable mold 46 of the die 40 by a mechanical conjunction mechanism such as a linking mechanism or the like. Therefore, when the movable mold 46 is moved in the mold-closing direction (the direction of arrow RE in FIG. 3 and the like), the first slide core 50 is moved in the first direction (the direction of arrow A in FIG. 4A and the like). In a mold-closed state of the die main body 42 (the die 40), a first direction side portion of the first slide core 50 protrudes from the face of the movable mold 46 at the side thereof at which the fixed mold 44 is disposed. The first direction side end of the first slide core 50 is formed in the shape of the vehicle width direction outer side face of the transverse plate 24 of the electric circuit accommodation portion 20 of the visor rim 10. Thus, the transverse plate 24 is molded by the fixed mold 44, the movable mold 46, the first slide core 50 and the like of the die 40.

A second slide core 52 is also provided at the movable mold 46 of the die 40. The second slide core 52 is made movable by a guide portion provided at the die 40 (not shown in the drawings) in a second direction (the direction of arrow B in FIG. 4A and the like) and the opposite direction to the second direction (a second opening direction). The second direction intersects both the mold-closing direction (the direction of arrow RE in FIG. 4A and the like) and the first direction that is the movement direction of the first slide core 50 (the direction of arrow A in FIG. 4A and the like). More specifically, the second direction is angled to a far side of the die 40 (the direction of arrow UP in FIG. 4A and the like) toward the mold-closing direction of the die 40 (the direction of arrow RE in FIG. 4A and the like).

A movement path of the second slide core 52 in the second direction (the direction of arrow B in FIG. 4A and the like) and the opposite direction overlaps with a movement path of the first slide core 50 in the first direction (the direction of arrow A in FIG. 4A and the like) and the opposite direction. An arrangement hole 54 that serves as an arrangement portion is formed in the first slide core 50. The arrangement hole 54 penetrates through the first slide core 50 in the second direction. A cross-sectional shape of the arrangement hole 54 cut in a direction orthogonal to the penetration direction of the arrangement hole 54 (that is, to the second direction) is slightly larger than a cross-sectional shape of a middle portion along the second direction of the second slide core 52. Thus, the second direction middle portion of the second slide core 52 may be disposed inside the arrangement hole 54.

In the mold-closed state of the die main body 42 (the die 40), as shown in FIG. 4B, the second slide core 52 is inserted into the arrangement hole 54 of the first slide core 50, and a second direction side portion of the second slide core 52 (the second direction is the direction of arrow B in FIG. 4B and the like) protrudes from the arrangement hole 54. Thus, in the mold-closed state of the die main body 42 (the die 40), the second slide core 52 is disposed in a state intersecting with the first slide core 50.

—Molding Method for the Visor Rim 10 Using the Die 40—

In a molding method for the visor rim 10 using the die 40 with the structure described above, the die main body 42 (the die 40) is closed by the movable mold 46 that structures the die main body 42 of the die 40 being moved in the mold-closing direction (the direction of arrow RE in FIG. 3 and the like). While the die main body 42 is being closed, the first slide core 50 operates in conjunction with the movement of the movable mold 46 and moves in the first direction (the direction of arrow A in FIG. 4A and the like).

When the movement of the first slide core 50 in the first direction is completed, the second slide core 52 operates in conjunction with the movement of the movable mold 46 in the mold-closing direction (the direction of arrow RE in FIG. 3 and the like) and moves in the second direction (the direction of arrow B in FIG. 4A and the like). Thus, the second slide core 52 is inserted into the arrangement hole 54 of the first slide core 50, leading with the second direction side end of the second slide core 52. When mold-closing of the die 40 is completed, the second direction side portion of the second slide core 52 protrudes from the arrangement hole 54 and the second slide core 52 intersects with the first slide core 50.

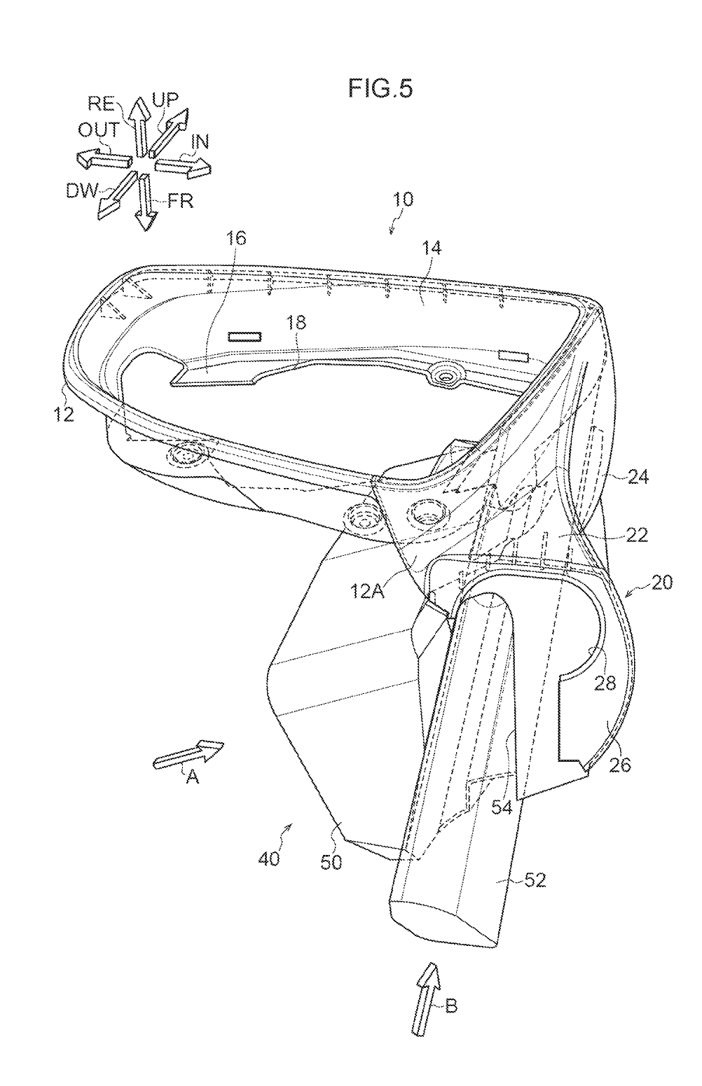

In this mold-closed state of the die main body 42 (the die 40), a synthetic resin serving as a molding material is charged into the inside of the die 40. Thus, the visor rim 10 is molded as shown in FIG. 5 by the synthetic resin hardening. As shown in FIG. 1 and FIG. 2, at the front side portion relative to the front and rear direction middle portion of the transverse plate 24 of the electric circuit accommodation portion 20 of the visor rim 10, the vehicle width direction outer side face of the transverse plate 24 is curved into a protruding shape that bulges in a direction that is angled to the lower side toward the vehicle width direction inner side.

The front side portion relative to the front and rear direction middle portion of the transverse plate 24 is curved toward the vehicle width direction outer side. As shown in FIG. 2, a portion of the transverse plate 24 is disposed at the front side of the rear plate 22 of the electric circuit accommodation portion 20 and the floor plate 16 of the mirror accommodation portion 14, opposing the rear plate 22 and the floor plate 16 in the front and rear direction. The front and rear direction is the mold-closing direction (the direction of arrow RE in FIG. 3 and the like) and the mold-opening direction (the direction of arrow FR in FIG. 3 and the like) of the movable mold 46 of the die 40. Therefore, the vehicle width direction outer side face of the transverse plate 24 and the front side face of the rear plate 22 form an undercut.

As shown in FIG. 5, in the molding method for the visor rim 10 using the die 40, in the mold-closed state of the die main body 42 (the die 40), the first direction side portion of the first slide core 50 protrudes from the face of the movable mold 46 of the die 40 at the side thereof at which the fixed mold 44 is disposed. Thus, the vehicle width direction outer side face of the transverse plate 24 of the electric circuit accommodation portion 20 of the visor rim 10, excluding the rear side portion of the upper portion of the transverse plate 24, and the front side face of the rear plate 22 of the electric circuit accommodation portion 20 are molded by the first slide core 50.

At the front side portion of the vehicle width direction inner side portion of the visor rim 10 that is at the front side relative to the rear plate 22 of the electric circuit accommodation portion 20, the rim portion 12 of the visor rim 10 and the transverse plate 24 of the electric circuit accommodation portion 20 oppose the mirror accommodation portion 14 in the vehicle width direction (the direction of arrow OUT and the direction of arrow IN in FIG. 5 and the like). The front side portion of the vehicle width direction inner side portion of the visor rim 10, which is at the front side relative to the rear plate 22 of the electric circuit accommodation portion 20, is provided at the mold-closing direction side (the direction of arrow RE in FIG. 5 and the like) relative to the first direction side portion (a portion at the side in the direction of arrow A in FIG. 5 and the like) of the first slide core 50, which protrudes from the face of the movable mold 46 of the die 40 at the side thereof at which the fixed mold 44 is disposed.

Therefore, the inner side of the front side portion relative to the rear plate 22 of the vehicle width direction inner side portion of the visor rim 10 forms an undercut with respect to movement of the first slide core 50 in the opposite direction to the first direction. Thus, the inner side face of the front side portion relative to the rear plate 22 of the vehicle width direction inner side portion of the visor rim 10 cannot be molded by the first slide core 50 alone.

In the molding method for the visor rim 10 using the die 40 with the structure described above, in the mold-closed state of the die main body 42 (the die 40), the second direction side portion (a portion in the direction of arrow B in FIG. 5 and the like) of the second slide core 52 protrudes from the arrangement hole 54 of the first slide core 50 of the die 40. Thus, a region of the inner side face of the front side portion of the vehicle width direction inner side portion of the visor rim 10 that is at the front side relative to the rear plate 22 of the electric circuit accommodation portion 20 (that is, inner side faces of the rim portion 12, the rear side portion of the upper portion of the transverse plate 24 of the electric circuit accommodation portion 20, and the mirror accommodation portion 14) and that cannot be molded by the first slide core 50 is molded by the second direction side portion of the second slide core 52.

In this molding method (fabrication method) for the visor rim 10 using the die 40, even though the visor rim 10 has a structure that includes an undercut that cannot be implemented by the first slide core 50 alone, the visor rim 10 including this undercut may be integrally molded. Therefore, an increase in a number of components of the electric door mirror device may be suppressed, and an increase in a number of steps for assembly of the electric door mirror device may be suppressed.

The visor rim 10 could, for example, be structured by plural parts that are separate bodies. The visor rim 10 could be formed by these parts being assembled, and thus undercuts during molding of these parts could be avoided. However, in a structure in which the visor rim 10 is formed by assembling plural parts, gaps, steps and the like are formed between the parts in the assembled state of the visor rim 10. The visor rim 10 is part of the structure of a door mirror device for a vehicle and is disposed outside a passenger compartment of the vehicle. During vehicle running, air currents flow along vehicle body surfaces of the vehicle. Gaps, steps and the like between parts of the visor rim 10 may cause resistance to air currents, and hence resistance to running of the vehicle, and may also cause the production of noise.

However, in this molding method (fabrication method) for the visor rim 10 using the die 40, the visor rim 10 is molded integrally. Therefore, the production of gaps, steps and the like as described above is suppressed. Consequently, an increase in resistance to air currents along vehicle body surfaces of the vehicle and hence in resistance to running of the vehicle may be suppressed, in addition to which the production of noise by the air currents may be suppressed.

The second slide core 52 of the die 40 is a structure that is inserted into the arrangement hole 54 of the first slide core 50, with the second direction side portion (a portion in the direction of arrow B in FIG. 4B and the like) of the second slide core 52 protruding from the arrangement hole 54. Consequently, the vehicle width direction outer side face of the transverse plate 24 of the electric circuit accommodation portion 20 of the visor rim 10 (the inner side face of the electric circuit accommodation portion 20 at the transverse plate 24) may be made continuous by the first slide core 50 and the second slide core 52 in a circumferential direction around an axial direction that is a direction intersecting both the first direction (the direction of arrow A in FIG. 4B and the like) and the second direction. Therefore, variations in a thickness dimension of the respective portions of the transverse plate 24 may be reduced. As a result, the production of sink marks and the like in the transverse plate 24 may be suppressed. Thus, a deterioration in molding characteristics of the transverse plate 24, and hence in molding characteristics of the visor rim 10, may be suppressed.

In the present exemplary embodiment, the arrangement hole 54 of the first slide core 50 that serves as the arrangement portion is a hole that penetrates in the second direction (the direction of arrow B in FIG. 4A and the like) and the opposite direction. However, the arrangement portion may be, for example, a groove that is formed penetrating in the second direction and that opens out in a direction intersecting both the first direction and the second direction. In other words, it is sufficient if the arrangement portion is a structure in which the second slide core 52 is disposed.

The present exemplary embodiment has a structure in which the second slide core 52 is inserted into the arrangement hole 54 of the first slide core 50 and the second slide core 52 is arranged in a state intersecting with the first slide core 50, that is, a structure in which a portion of the first slide core 50 and a portion of the second slide core 52 overlap in the first direction (the direction of arrow A in FIG. 4A and the like). However, a structure is possible in which the first slide core 50 and second slide core 52 do not overlap in the first direction, with, for example, the first slide core 50 and second slide core 52 being disposed to intersect in a state in which an outer face of the second slide core 52 is abutted against an outer face of the first slide core 50.

The present exemplary embodiment has a structure in which the first slide core 50 and the second slide core 52 operate in conjunction with the movable mold 46 of the die 40. However, a structure is possible in which one or both of the first slide core 50 and the second slide core 52 moves independently of the movable mold 46.

In the present exemplary embodiment, the present disclosure is applied to processing of an undercut at the side of the visor rim 10 at which the electric circuit accommodation portion 20 is disposed. However, the present disclosure may also be applied to processing of an undercut at an alternative portion of the visor rim 10. Further, the present disclosure may be applied to molding of alternative components of a door mirror device such as a visor cover of the door mirror device and the like, regardless of whether the door mirror device is electrical or manual. The present disclosure may also be applied to vehicle cabin exterior equipment components to be disposed outside the passenger cabin of a vehicle other than a door mirror device, the present disclosure may be applied to molding of components that are disposed inside the passenger cabin of a vehicle, and the present disclosure may be applied to molding of components and products for applications other than vehicles.

In the present exemplary embodiment, the molding material of the visor rim 10 that serves as the molded article is a synthetic resin. However, the molding material of the molded article may be a material other than a synthetic resin, such as a metal or the like, and may be a blended material of a synthetic resin and metal. The molding material of the molded article is not particularly limited.

What is claimed is:

1. A method of molding a molded article, the method employing a die provided with:
a die main body including a movable mold and a fixed mold;
a first slide core that is disposable inside the die main body; and
a second slide core that is disposable inside the die main body in a state intersecting with the first slide core,
and the method comprising:
a mold-closing step including
closing the die main body,
disposing the first slide core inside the die main body, and
disposing the second slide core inside the die main body to intersect with the first slide core; and
a charging step of charging a molding material into the inside of the die, an undercut portion of the molded article being molded by the first slide core and the second slide core.

2. The method according to claim 1, wherein the mold-closing step includes, when the die main body is being closed:
moving the movable mold in a mold-closing direction;
moving the first slide core in a first direction that intersects the mold-closing direction; and
moving the second slide core in a second direction that intersects both the mold-closing direction and the first direction.

3. The method according to claim 1, wherein the mold-closing step includes disposing the second slide core in the state in which the second slide core intersects with the first slide core by:
disposing the second slide core at an inside of an arrangement portion formed in the first slide core, the second slide core being movable in the second direction and an opposite direction thereto, and
causing a second direction side portion of the second slide core to protrude to an outside of the arrangement portion in a state in which the mold has been closed.

4. A molded article comprising:
a molded article main body that opens out in a predetermined direction; and
an undercut portion formed integrally with the molded article main body,
the undercut portion including regions that oppose one another in the predetermined direction,
a space between the regions that oppose one another in the predetermined direction opening out to a first opening direction side, the first opening direction intersecting the predetermined direction, and
a first opening direction middle portion of the space between the regions that oppose one another in the predetermined direction opening out to a second direction side, the second direction intersecting both the predetermined direction and the first opening direction.

5. A die comprising:
a die main body including a movable mold and a fixed mold, a molding material for a molded article being charged into an inside of the die main body in a mold-closed state;
a first slide core disposed inside the die main body, the first slide core molding an undercut portion of the molded article; and
a second slide core disposed inside the die main body to intersect with the first slide core, the second slide core molding the undercut portion together with the first slide core.

6. The die according to claim 5, wherein:
the first slide core is movable in a first direction and an opposite direction thereto, the first direction intersecting a mold-closing direction that is a movement direction of the movable mold when the die main body is being closed; and
the second slide core is movable in a second direction and an opposite direction thereto, the second direction intersecting both the mold-closing direction and the first direction.

7. The die according to claim 5, further comprising an arrangement portion formed in the first slide core, the second slide core being disposed at an inside of the arrangement portion to be movable in the second direction and the opposite direction thereto,
wherein, in the mold-closed state of the die main body, a second direction side portion of the second slide core protrudes to an outside of the arrangement portion.
